(19) United States
(12) Patent Application Publication
(10) Pub. No.: US 2014/0200935 A1
(43) Pub. Date: Jul. 17, 2014

(54) Product Value Dynamic Lab Test Equipment Control, Data Analyzer and Method

(71) Applicant: Canadian Standards Association, Toronto (CA)

(72) Inventors: Adam Davies, Marietta, GA (US); Maria Baker, Rocky River, OH (US)

(73) Assignee: CANADIAN STANDARDS ASSOCIATION, Toronto (CA)

(21) Appl. No.: 14/153,479

(22) Filed: Jan. 13, 2014

Related U.S. Application Data
(60) Provisional application No. 61/751,547, filed on Jan. 11, 2013.

(51) Int. Cl. G06Q 10/06; G06Q 30/06

(52) U.S. Cl. CPC G06Q 10/0637; G06Q 30/0623; G06Q 40/06
USPC 705/7.11

(57) ABSTRACT

A system for user directed real-time manipulation of data is disclosed that allows the manipulation and weighting of data, and, in particular, testing data concerning various attributes of a product or service and that displays the results thereof to a user.

### CROSS REFERENCE TO RELATED APPLICATIONS

The current application claims the benefit of U.S. provisional application Ser. No. 61/751,547, filed Jan. 11, 2013, the entire disclosure of which is incorporated herein by reference.

### TECHNICAL FIELD

Embodiments of the present disclosure relate generally to computer systems, tools, displays and methods for analyzing product value, providing visual representations for business rationale, and for driving strategic decisions in purchases and investments as well as the ability to control lab test equipment either by analyzing data values collected in real time or by user input or both.

### BACKGROUND

The disclosure contemplates that it may be difficult to make a confident purchase or contract decisions between a plurality of similar goods and services. For example, there may be attributes for items of a particular good or services, with attribute A for item 1 outperforming the same attribute on item 2, but attribute B for item 2 outperforming the same attribute on item 1. However, overall, attribute B may be a more important decision consideration than attribute A. Adding to the complexity, a plurality of attributes with differing strengths and differing weights may apply to a plurality of products or services, creating uncertainty to purchasing or business decisions. In the past, while there have been methods and systems that have addressed some of these issues, these have generally been incomplete, unsatisfactory, or both. Accordingly, it would be desired to have a method and/or system for assisting in making business decisions (such as purchase or contract decisions) that considers multiple factors and may be weighted as desired by a user.

### SUMMARY

The present disclosure is directed to a system for dynamic weighting and analysis of both quantifiable and non-quantifiable data to create a resulting value index which can quantify a plurality of attributes, both quantifiable as well as subjective, regardless of whether the quantified attributes are inherently quantifiable or inherently subjective. As used herein, a user may be a person, a team, or an organization.

In accordance with the disclosure, business rationale that drives strategic decisions may be quantified to a comparable index. The system in the disclosure provides for a vendor negotiation tool, and real time results. The system may take more than one attribute of a good, item, or service into account. Both objective and subjective attributes may be taken into account. Quantifiable, and non-quantifiable data may be factored into the analysis. Attributes may be customized as to number and feature, attributes may be considered individually or collectively and each attribute weight may be customized by user input. Users may also input expected values or test value tolerances or acceptable standard deviations which may serve as lab test control parameters that will stop a test if data values outside of the set range or set standard deviation are realized. A plurality of items may be compared. In one aspect of a preferred embodiment, each item may be of the same good or service, and may have similar attributes.

### BRIEF DESCRIPTION OF THE DRAWINGS

FIG. 1 shows a screen shot of an example interactive system displaying the high value attribute input area, and interactive scroll bars to advance and assign a weight to each product test category or subjective attribute;

FIG. 2 shows a screen shot of an example interactive system displaying the low value user input area;

FIG. 3 shows a screen shot of an example interactive system, maintaining a running total of attribute weights;

FIG. 4 shows a screen shot of an example interactive system providing a warning for an unacceptable weight distribution;

FIG. 5 shows a screen shot of an example interactive system displaying the subjective data input area;

FIG. 6 shows a screen shot of an example interactive system displaying the quantitative values, performance, and weights for different items of a particular item type;

FIG. 7 shows a screen shot of an example interactive system displaying rankings and value changes from real-time, of changing a particular attribute weight for a particular item; and

FIG. 8 shows a block diagram of the flow of data and control signals between components of the system.

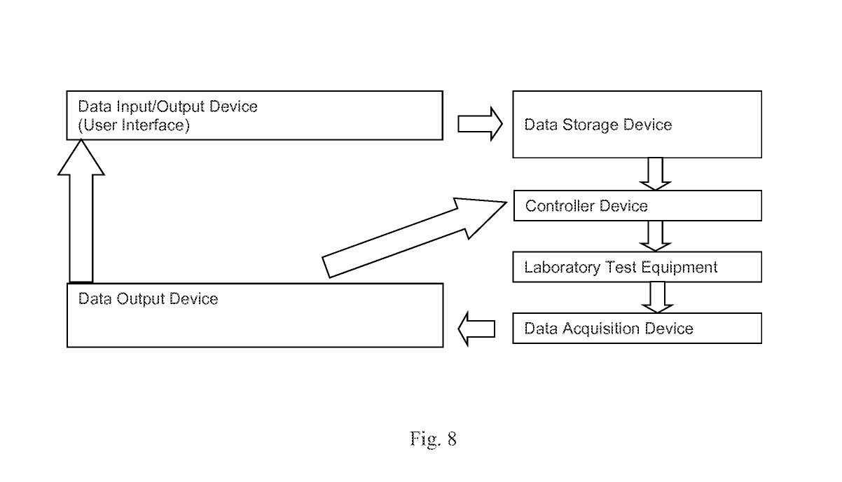

### DETAILED DESCRIPTION

Embodiments of the present disclosure generally relate to an interactive multi-criteria decision-making tool for use in connection with a testing system, that provides the flexibility to set testing parameters, adjust testing parameters, control test equipment, acquire test data and analyze decision-making criteria in real time. Further, the present disclosure provides a method and apparatus for using such a tool that may include printing or saving the results thereof and which may be hosted by an independent IT service or by a proprietary IT service and may be accessed via a networked desktop computer or mobile device, etc. In accordance with one aspect of the disclosure, the system may provide the ability to analyze various attributes of a product or service designated by a user, for a comparison of the attributes to create a comparable index of value for each item. The system may include a graphical representation of results, which may include a comparison of the selected attribute, which may display criteria including, but not limited to: non-dimensional attribute performance scale, cost scale, scaled value index, linear, (average cost scale), linear (average total performance scale), linear (average value index), and any other criteria that a user may determine valuable (i.e. any criteria that may drive strategic decisions related to the product/service).

Further in accordance with embodiments of the present disclosure, data points, once collected, for selected attribute[s] may be normalized. Normalization refers to adjusting data values measured with different dimensions such as weight, acceleration, size, etc. on different scales to a dimensionless common scale thus, allowing for a scaled, unbiased, or dimensionless comparison of a variety of data types.

In accordance with some aspects of the disclosure, the system disclosed herein may be customized to a user's needs. Specifically, in accordance with at least one embodiment of the disclosure, at least one, or a plurality of, attributes may be weighted, indexed, and compared to each other graphically. Example attributes a user may designate may include durability, functionality, performance, cost, etc. One or more users may use the customized system to distribute the weights (importance of the attribute) between the attribute[s], in increments between any number greater than zero and 100 percent, although this may vary for other embodiments. When the weights provided are as a percentage, as here, the division of weights between the plurality of attributes should add up to 100%.

The system disclosed herein also contemplates a multiple user embodiment wherein each of the multiple users may have different or competing decision-making interests. In accordance with such an embodiment, a first attribute (attribute A) may be more important to a first user (user 1) while a second attribute (attribute B) may be more important to a second user (user 2). In an exemplary, but non-limiting, embodiment of such a situation exemplary user 1 and user 2 may comprise a retail vendor quality manager and a retail merchandising manager, respectively. As can be readily understood to those of ordinary skill in the art, in such a scenario a quality manager may be more interested in cycle performance of a particular product while a merchandising manager may be more interested in price point for that product.

In another exemplary embodiment in accordance with the present disclosure, a user may be provided with an input section for quantifiable data. In such an embodiment, data which has a numerically quantifiable attribute, such as lab test results, may be considered to be quantifiable data. In accordance with this embodiment, the quantifiable data may be assigned a certain weight by the user according to the user's business needs, personal preferences, etc. The weights assigned to each attribute may be input by the user via an input device to the system, and may be adjusted at any time, including, but not limited to, during collection of the data. Further, the results of weighting adjustments may be observed in real-time as the user adjusts the weights. As discussed above, as with all percentage derived weighting, the total weight assigned to all the attributes should add up to 100 percent. Input of weighting adjustments may be accomplished in any manner known by those of ordinary skill in the art including, but not limited to, direct keypad, advance arrows, or any other method which allows a numerical weight to be adjusted.

In further accordance with the disclosure, the quantifiable data input section may be divided into a plurality of sections if desired or whether the desired values for quantifiable data are high, low or targeted may be selected by the user at the time the attribute is input into the system. For example, the quantifiable data section could include a means to designate “high” values as desirable and a means to designate “low” values as desirable, and a means to designate targeted values. In one embodiment, attributes wherein a “high” normalized or scaled value is considered desirable would be placed in a “high” section and attributes wherein a “low” normalized or scaled value is considered desirable would be placed in a “low” section. Consistent therewith, a “targeted” value may be determined by a user for a particular attribute and the system may display whether the attribute for the product under test exceeds or falls short of the desired target value. One example of a targeted value may be air pressure where a specific air pressure is desired and the actual value may meet, exceed or fall short of the desired value. This functionality distinguishes the three sections so low normalized or scaled value quantifiable data, high normalized or scaled value quantifiable data, and certain targeted value data (whether low or high) is not erroneously classified as undesirable.

Also consistent with the present disclosure, another input section may be provided for non-quantifiable data, i.e. subjective data, which may be ordinally ranked and weighted by the user for consideration in a value index. This ordinal data feature thus allows a user to rank and assign a weight to subjective features allowing users to include and compare non-quantifiable data or attributes on the same or similar scale as quantifiable data, and thus factor in both quantifiable and non-quantifiable product attributes that are important to a user or organization. Examples of non-quantifiable attributes may include product color, strategic initiatives, and overexposure within a single country of origin, etc. In the non-quantifiable data input section, users may provide the relative importance rankings, and assign a weight to the importance of the non-quantifiable data or attribute.

As described above, the system and method disclosed herein may separate attributes into high, low, ordinal and targeted value data categories. Also in accordance with the disclosure, the system may analyze data and compare it to historical data generated from a previous test of the same or similar products/services. In accordance with such an embodiment, using an interactive display or spreadsheet, a user may assign a weight to each attribute to generate a partial contribution of that attribute to a total performance score. The input may be made by using scrolling arrows, by inputting a number with a keypad, or any other input methods which are known to those of ordinary skill in the art. The weight may be attributed to each attribute, once again out of a total percentage weight of 100. The weighting may be distributed between all sections being utilized. Data may then be scaled using any method as are known to those of ordinary skill in the art. Some examples of acceptable scaling methods known to those of ordinary skill in the art include, but are not limited to the Additive Weighting Technique (AWT) or the Hurwicz procedure.

The system disclosed herein may have utility in a multitude of various different applications. One non-limiting example includes the use of the system and method disclosed herein during vendor negotiations. For example, a vendor may use the system to demonstrate how the vendor's product fares favorably against similar competitor products. More specifically, a vendor may demonstrate the impact of vendor driven incentives such as price changes dynamically, in real-time, providing a persuasive negotiation tool as well as a front line of risk mitigation when faced with live and/or time-sensitive negotiations and decisions.

Additionally, the system disclosed herein may have utility in demonstrating an overall product value by weighting and displaying many attributes dynamically. This is in contrast to prior art systems which may have been generally limited to the display of single attributes or which do not allow for customizable weighting or customizable weighting in real-time. In accordance herewith, for example, cost data may be scaled and made dimensionless using known statistical methods. Next, a user may then assign individually-determined weights to the cost and performance portions of the formula, thereby generating a cost vs. performance value index. Thus the weighting system disclosed herein allows flexibility in situations where one or more particular performance attribute(s) may be more important than others and/or overall performance may be more important than cost as cost is only one of many attributes weighted and considered.

Further, the system disclosed herein allows for the interactive manipulation and visualization of an analytical result and control of laboratory test equipment. Specifically, the disclosure contemplates and discloses: (1) a method to control a machine process; (2) a data acquisition means to collect data specific to at least one product attribute, of at least one product sample from at least one discrete machine; (3) software to execute the method and automatically normalize the data; (4) software to automatically populate the normalized data into an interactive multi-criteria decision-making data analysis program; and (5) software to control a machine process based on both interactive inputs and data acquisition results and a real-time numeric and visual representation of the interactively manipulated analytical result.

In accordance with the present disclosure, a machine (such as a computer) may acquire quantitative and qualitative data, and process according to the disclosure. An output may be provided with a display monitor, paper printout, or other data signal (i.e. automated ordering or automatic population of a product specification may take place or a machine control signal may be generated).

A data acquisition device in accordance with the disclosure may include test equipment or other data acquisition devices which interface between laboratory test equipment, data storage devices, and, for example, a computer processor. The quantitative data may be collected by the device(s) and then sent directly to a computer processor. In this manner, the data collection process maybe streamlined, and minimizes manual input error of quantitative amounts used for the calculations. This data may be acquired with any number of manufactured or custom made data acquisition devices as are known in the art. It would be apparent to a person of ordinary skill in the art that any appropriate data collection means may be designed or selected based on the requirements of the product being analyzed, tested, compared, etc.

In accordance with the disclosure, a software program and underlying algorithm may be executed by a computer processor to perform the mathematical process of data normalization or scaling. The software program may retrieve data stored in the data acquisition device, a data storage device, etc. which may then be used to populate the quantitative and qualitative fields used by the system or to generate a control signal to the test equipment. It may also process data in real time as it is acquired by the data acquisition device.

In accordance with the disclosure, a software program may be utilized to allow a user to interactively manipulate data, producing both numeric and graphical results. In accordance therewith, the software may allow a user to assign a weight to each tested attribute, indicating the importance of that attribute to the user's decision-making process. Each attribute may be given a normalized numerical score based on the assigned weight and the quantitative value. Each attribute may be compared to the other attributes with a normalized score. Each attribute for a particular option may then be totaled for a total score, and the various options may be compared by this score. Based upon the graphical output, a user may make an informed decision on which option to select based on the numeric and graphical representation of the system's analysis. More specifically, in accordance with the disclosure herein, a user may observe in real time the displayed analytical result of changes in attribute “weights.”

In one aspect of and embodiment of the disclosure, a user may choose to control the laboratory equipment running the test by direct input or by inputting parameters that will cause the laboratory equipment to respond as desired if the set parameters are either not met or are exceeded. This may be advantageous in interrupting and/or stopping a destructive test that is not performing as expected to troubleshoot possible errors (such as the use of lab test equipment that does not have the appropriate measurement range). In accordance with the disclosure, data may be obtained by multiple sources. Specifically, in addition to any data collected via a data acquisition device, a user may manually input data to be considered in the decision-making process. The data collected via a data acquisition device and the keyed-in data may be analyzed simultaneously to produce a final analytical result such as a performance or value index. Data may also be analyzed as it is collected in real time, with the displayed results updated accordingly.

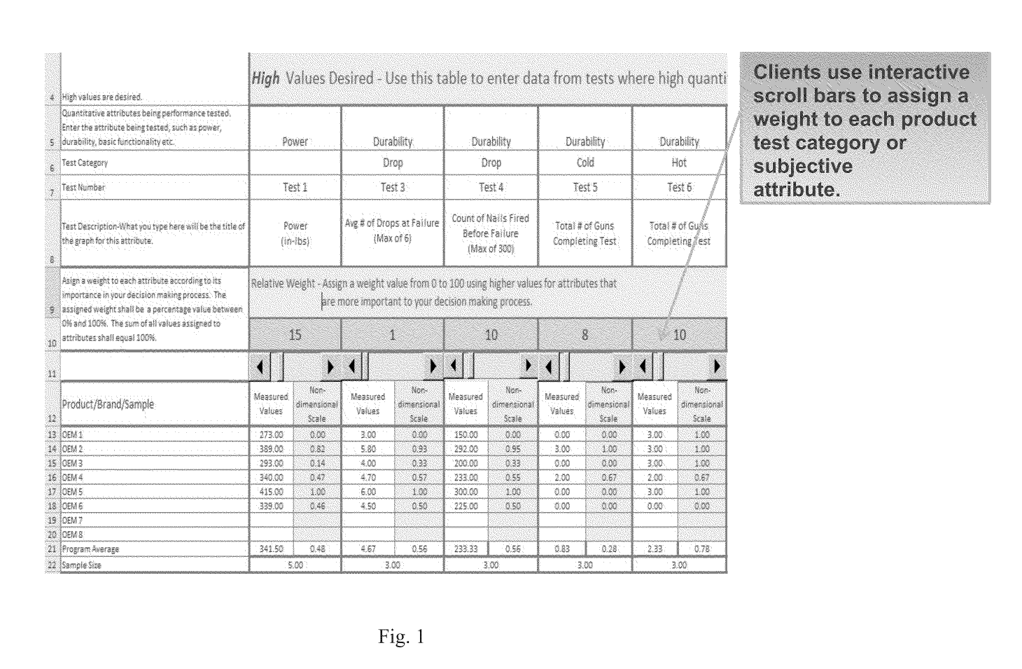

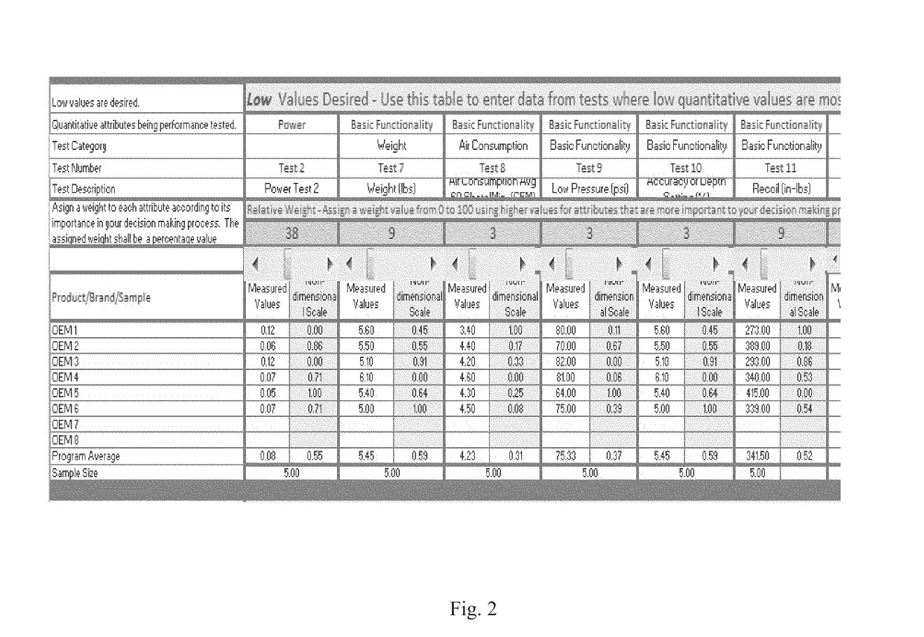

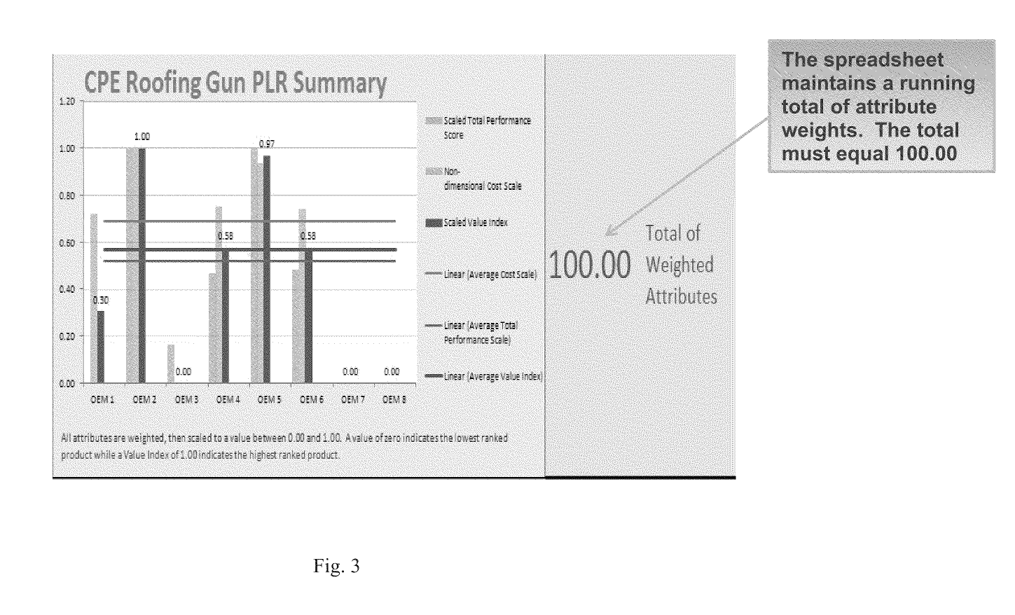

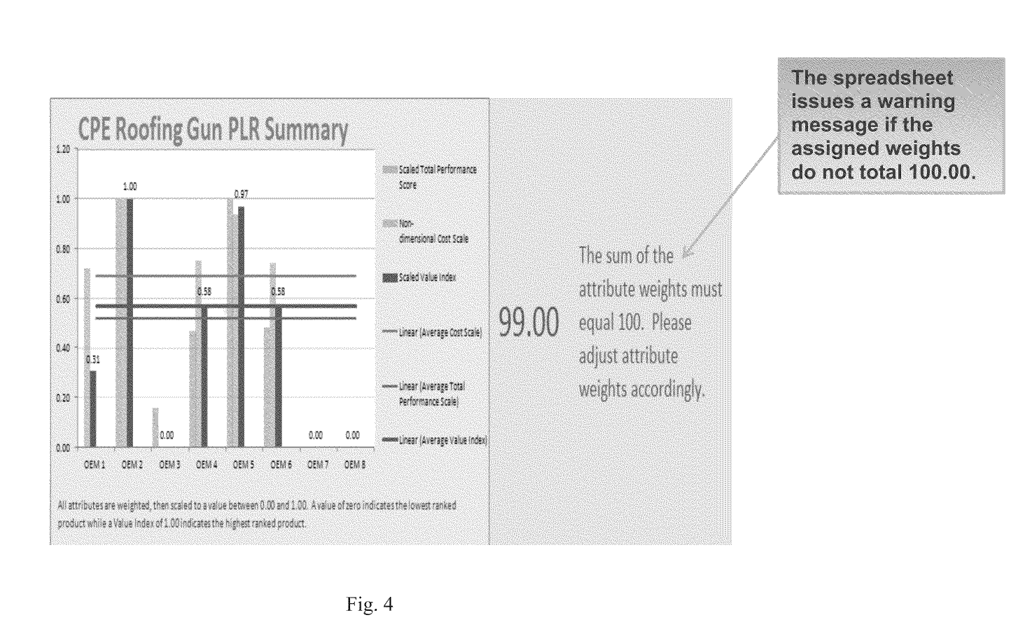

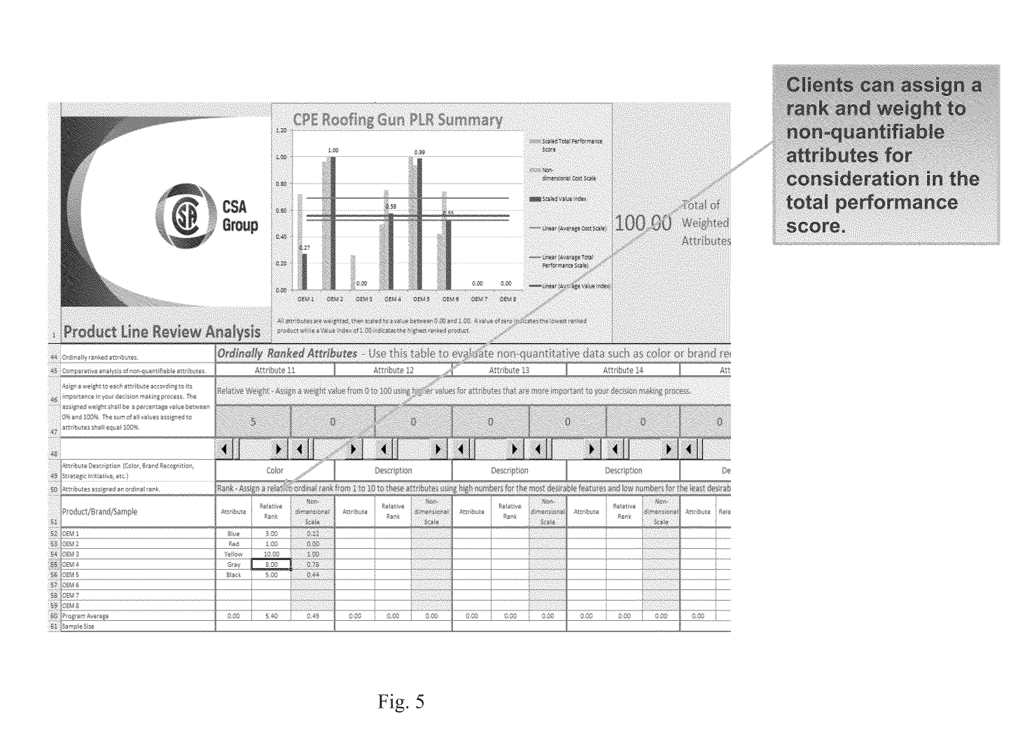

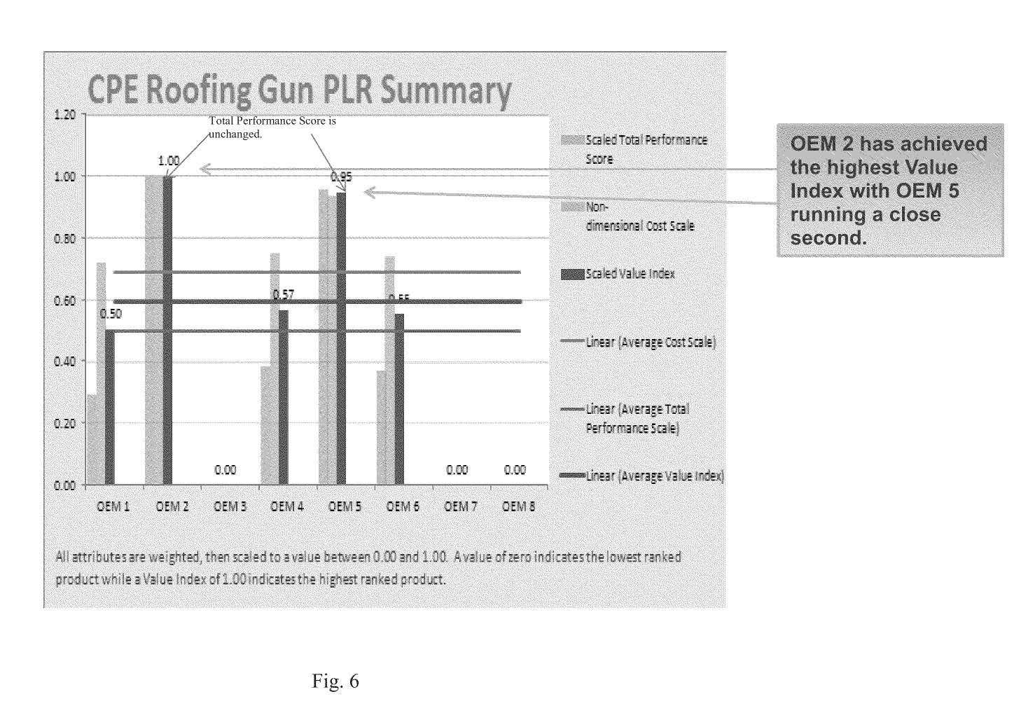

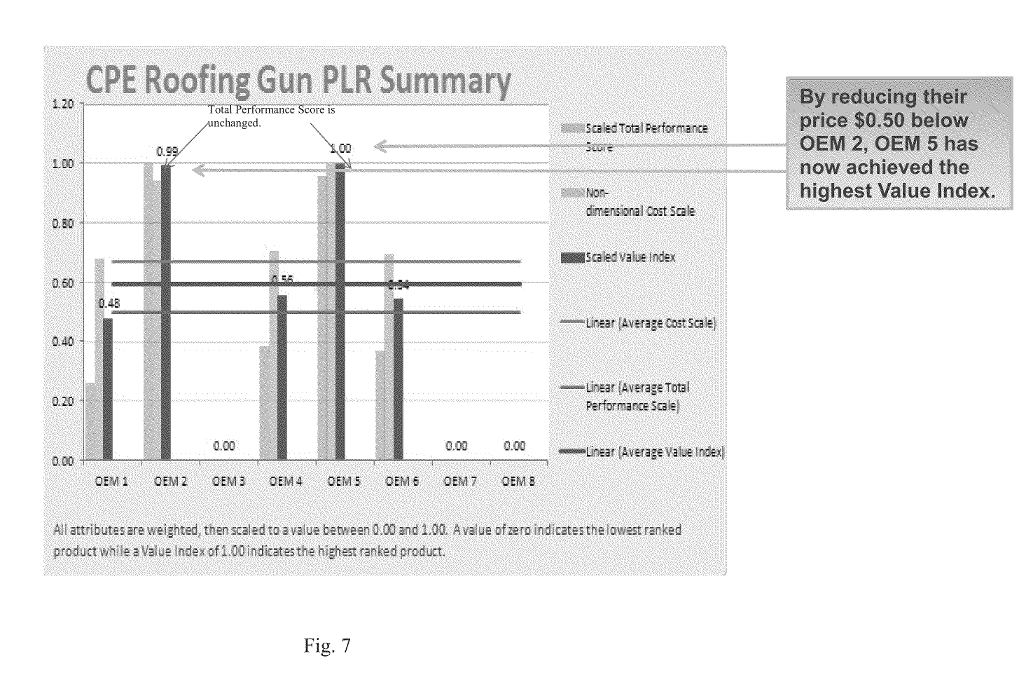

As shown best in FIGS. 1-7, an example system in accordance with the disclosure allows interactive input and provides a display. In such an exemplary embodiment a control means, such as a relay, may be used to control a laboratory test machine and a data acquisition means such as a computer battery analyzer (CBA).

In accordance with the exemplary embodiment shown in FIGS. 1-7, the CBA may use an on-board microcontroller and each CBA may be computer calibrated for high accuracy. In this embodiment, the electronic load may use a pulse width modulation system to control a pair of power MOS FET transistors using both electronic and software current regulation. The on-board microcontroller may also provide the USB interface to the computer. In accordance with that embodiment, the computer battery analyzer is an exemplary data acquisition device that collects battery test data and communicates that data to a computer. A software program may be then used to reformat, normalize, and populate the data into a multi-criteria decision-making graphical user interface (GUI) in accordance with the present disclosure. Next, also in accordance with the disclosure herein, the user may then interactively manipulate the data via the GUI and produce a customized numeric and graphical test result analysis such as a performance index.

One exemplary application in which the disclosed system may be used in accordance with this disclosure includes, but is not limited to, retail buying decisions. For example, the system may be utilized in situations where a retailer is trying to decide which power tool to carry in their store. In such situations, the power tools being considered may be evaluated by performance testing, including, but not limited, to such attributes as cycle testing and power efficiency wherein it is determined that brand 1 outperforms brand 2 in cycle testing while brand 2 outperforms brand 1 in power efficiency. In such an example, if the user interactively assigns cycle testing a higher “weight” than power efficiency, then purchasing brand 1 would be numerically and graphically represented with a higher performance index. However, if the user assigns a higher “weight” to power efficiency, then brand 2 would be numerically and graphically represented with a higher performance index.

To provide additional context for various aspects of the current disclosure, the following discussion is intended to provide a brief, general description of a suitable computing environment in which the various aspects of the current disclosure may be implemented. While example embodiments of the current disclosure relate to the general context of computer-executable instructions that may run on one or more computers, those skilled in the art will recognize that the embodiments also may be implemented in combination with other program modules and/or as a combination of hardware and software.

Generally, program modules include routines, programs, components, data structures, etc., that perform particular tasks or implement particular abstract data types. Moreover, those skilled in the art will appreciate that aspects of the inventive methods may be practiced with other computer system configurations, including single-processor or multiprocessor computer systems, minicomputers, mainframe computers, as well as personal computers, hand-held wireless computing devices, microprocessor-based or programmable consumer electronics, and the like, each of which can be operatively coupled to one or more associated devices. Aspects of the current disclosure may also be practiced in distributed computing environments where certain tasks are performed by remote processing devices that are linked through a communications network. In a distributed computing environment, program modules may be located in both local and remote memory storage devices.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media (i.e., non-transitory computer readable media) includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer.

An exemplary environment for implementing various aspects of the current disclosure may include a computer that includes a processing unit, a system memory and a system bus. The system bus couples system components including, but not limited to, the system memory to the processing unit. The processing unit may be any of various commercially available processors. Dual microprocessors and other multi-processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory may include read only memory (ROM) and/or random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (HDD) (e.g., EIDE, SATA), which internal hard disk drive may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media may provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the current disclosure.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

It is within the scope of the disclosure that a user may enter commands and information into the computer through one or more wired/wireless input devices, for example, a touch screen display, a keyboard and/or a pointing device, such as a mouse. Other input devices may include a microphone (functioning in association with appropriate language processing/recognition software as known to those of ordinary skill in the technology), an IR remote control, a joystick, a game pad, a stylus pen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer may include other peripheral output devices, such as speakers, printers, etc.

The computer may operate in a networked environment using logical connections via wired and/or wireless communications or data links to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections or data links could include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet. For the purposes of the current disclosure a data link between two components may be any wired or wireless mechanism, medium, system and/or protocol between the two components, whether direct or indirect, that allows the two components to send and/or received data with each other.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, n, etc.)) and Bluetooth™ wireless technologies. Thus, the communication may be a predefined structure as with a conventional network or simply an ad hoc communication between at least two devices.

The system may also include one or more server(s). The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

It will be apparent to those skilled in the art that various modifications and variations may be made to the data analyzer system and method disclosed herein without departing from the scope of the disclosure. Other embodiments of the system and method disclosed herein will be apparent to those skilled in the art from consideration of the specification and practice of the disclosed method. It is intended that the specification and examples be considered as exemplary only, with a true scope of the disclosure being indicated by the following claims and their equivalents.

1. A system for user directed real-time manipulation of data comprising;
a user input device;
a display for displaying information to a user;
a non-transitory memory component containing computer instructions for instructing a computer including stored information and information inputted in real-time by a user;
wherein the display displays to a user at least one product or service having at least two attributes, each attribute having a value attributable thereto, thereafter allowing the user to assign weights to the attributes through the input device, computing, based upon the assigned weights, a single value, and displaying the value through the display, to the user.

2. The system for user directed real-time manipulation of data of claim 1 wherein the user may adjust the assigned weights of the attributes at any time, including during data collection.

3. The system for user directed real-time manipulation of data of claim 1 allowing the input and weighting of quantifiable data and non-quantifiable data.

4. The system for user directed real-time manipulation of data of claim 1 wherein at least one of the values of one of the attributes is a quantifiable value derived from testing of the product or service.

5. The system for user directed real-time manipulation of data of claim 1 wherein at least one of the values of one of the attributes is a value inputted by a user.

6. The system for user directed real-time manipulation of data of claim 1 wherein cost data comprises one attribute and performance data comprises another attribute.

7. The system for user directed real-time manipulation of data of claim 6 wherein the cost data is scaled and made dimensionless.

8. The system for user directed real-time manipulation of data of claim 1 wherein data relating to at least one of the attributes is acquired directly into the non-transitory memory component directly from laboratory test equipment.

9. The system for user directed real-time manipulation of data of claim 1 wherein the value is displayed through the display graphically.

10. The system for user directed real-time manipulation of data of claim 1 wherein the values is displayed through the display numerically.

11. The system for user directed real-time manipulation of data of claim 1 wherein the system provides a warning to the user if the selected weights do not add up to 100%.

12. A system for user directed real-time manipulation of data comprising;
a user input device;
a display for displaying information to a user;
a non-transitory memory component containing computer instructions for instructing a computer including stored information and information inputted in real-time by a user;
wherein the display displays to a user at least two products or services having at least two attributes each, each attribute having a value attributable thereto, at least one of said values comprising a quantifiable value derived from testing of the product or service, thereafter allowing the user to assign weights to the attributes through the input device, computing, based upon the assigned weights, a single value, and displaying the value through the display, to the user.

13. The system for user directed real-time manipulation of data of claim 12 wherein the user may adjust the assigned weights of the attributes at any time, including during data collection.

14. The system for user directed real-time manipulation of data of claim 12 allowing the input and weighting of quantifiable data and non-quantifiable data.

15. The system for user directed real-time manipulation of data of claim 12 wherein at least one of the values of one of the attributes is a value inputted by a user.

16. The system for user directed real-time manipulation of data of claim 12 wherein cost data comprises one attribute and performance data comprises another attribute.

18. The system for user directed real-time manipulation of data of claim 12 wherein the value is displayed graphically to the user as at least one of a scaled total performance score, a non-dimensional cost scale, a comparison to historical data, a scaled value index, and/or as a linear display, namely average cost scale, average total performance scale, or average value index.

19. The system for user directed real-time manipulation of data of claim 12 wherein data relating to at least one of the attributes is acquired directly into the non-transitory memory component directly from laboratory test equipment.

20. A system for user directed real-time manipulation of data comprising;
a user input device;
a display for displaying information to a user;
a non-transitory memory component containing computer instructions for instructing a computer including stored information and information inputted in real-time by a user;
wherein the display displays to a user at least two products or services having at least two attributes each, each attribute having a value attributable thereto, at least one of said values comprising a quantifiable value derived from testing of the product or service, thereafter allowing the user to assign weights to the attributes through the input device, computing, based upon the assigned weights, a single value, and displaying the value through the display graphically to the user wherein data relating to at least one of the attributes is acquired directly into the non-transitory memory component directly from laboratory test equipment.
